(19) United States
(12) Patent Application Publication
(10) Pub. No.: US 2010/0324953 A1
(43) Pub. Date: Dec. 23, 2010

(54) METHOD AND SYSTEM FOR DETERMINING ENTITLEMENTS TO RESOURCES OF AN ORGANIZATION

(75) Inventors: Bob Janssen, Lage Zwaluwe (NL); Adrie Sweep, Breda (NL)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: REAL ENTERPRISE SOLUTIONS DEVELOPMENT B.V., 'S-HERTOGENBOSCH (NL)

(21) Appl. No.: 12/532,799

(22) PCT Filed: Mar. 30, 2007
(86) PCT No.: PCT/EP2007/053101

§ 371 Date: Sep. 3, 2010

(51) Int. Cl. G06Q 10/00

(52) U.S. Cl. 705/7

(57) ABSTRACT

The invention relates to a method and system for determining one or more valid entitlements for one or more persons or roles to one or more resources of an organization. Person classification data, role classification data, role constraint data and/or entitlement constraint data are supplied to an inference engine that provides an inference result set defining valid entitlements of a person or role to one or more resources.

### FIELD OF THE INVENTION

The invention relates to a method and system for determining entitlements of persons to resources of an organization. The invention also relates to a computer program product comprising program code portions for performing steps of such a method.

### BACKGROUND OF THE INVENTION

Most companies possess a considerable amount of valuable assets or resources. Examples of such resources include e.g. computer applications, computer source code, computer files, accounts, databases and tangible assets such as laptops, mobile telephones etc. These assets or resources are intended to be used by employees and/or other individuals for operating the business. However, companies desire to exercise control as to which persons are entitled to use which resources.

The first systems and methods to obtain an overview of entitlements of employees to particular resources were permission based systems. In these systems, IT administrative staff fills databases with data concerning the employees and the entitlements to resources of these employees. Permission to use resources is only linked to the personal data of the employees. These methods and systems do not allow the use of general compliance rules and the assessment of whether or not an employee is permitted to use a resource is dependent on the person performing the assessment.

Role Based Access Control (RBAC) systems provide a next generation of systems for determining permission of persons to use resources. RBAC is an automatic provisioning system that provides permissions to a person to access certain resources available over a network based on a person's role within an organization. In these systems, IT administrative staff fills person databases, role databases and entitlement databases using data of the person, his role and the entitlements that are defined for these persons and/or roles. However, as with permission based methods and system, these RBAC methods and systems do not allow the use of general compliance rules and the assessment of whether or not an employee is permitted to use a resource is still dependent on the person performing the assessment.

With the trend to ever more complex organizational structures of companies, methods and systems for determining entitlements have become more advanced by using organizational data derived from the model of the organization. Examples of such methods and systems include U.S. Pat. No. 6,985,955 and Enterprise Dynamic Access Control (EDAC), Version 2, Prepared for Commander, U.S. Pacific Fleet, retrievable from http://csrc.nist.gov/rbac. In these methods and systems a further set of data is entered by IT administrative staff relating to organizational information and links to and from information relating to the persons, roles, and entitlements should be entered in the system. In these methods and systems, constraints can be defined in order to check general compliancy rules, therewith avoiding a mere personal assessment whether or not a person may access a resource.

Clearly, dependent on the size of the organization and the rate with which people join or leave the organization or change roles, maintenance of an appropriate system for determining entitlements to resources becomes an increasingly more difficult and time-consuming task for IT administrative staff. In particular, the methods and systems described in the previous paragraph require IT administrative staff to enter huge amounts of data relating to persons, roles, organizational aspects and entitlements and the mutual links between these data. Only after entering of these data and links, it becomes apparent whether the entitlements obtained for a particular person meet the compliancy rules of the organization.

### SUMMARY OF THE INVENTION

It is an object of the invention to provide an improved method and system for determining one or more valid entitlements for one or more resources of an organization using a computer system in a complex organization.

To that end, a method of determining one or more valid entitlements for one or more persons to one or more resources of an organization using a computer system is proposed. The computer system comprises an inference engine and an organizational model database, a person database, a role database and an entitlement database. The organizational database contains organizational classification data defining one or more aspects of the organization. The person database contains person identification data and person classification data. The person identification data contain data of at least one person of the organization. The person classification data comprise at least one of the organizational classification data defining one or more of the aspects of said organization for the person, role classification data defining one or more roles of the person in the organization and entitlement classification data defining one or more entitlements for said person. The role database contains roles classification data and role constraint data. The role classification data comprise organization classification data defining one or more aspects of said organization for roles available in said organization and entitlement classification data defining entitlements for the role. The role constraint data relate to at least one of the organizational classification data constraining one or more of the available roles to one or more aspects of the organization and the person classification data constraining one or more of the available roles to one or more of the persons of the organization. The entitlement database contains entitlement identification data and entitlement constraint data. The entitlement identification data define one or more resources of the organization. The entitlement constraint data relate to at least one of the organizational classification data constraining entitlement to the one or more resources to one or more aspects of the organization, the role classification data constraining entitlement to the one or more resources to one or more available roles in said organization and the person classification data constraining entitlement to the one or more resources to one or more of said persons. The method comprises the step of feeding at least one of said personal classification data and said role classification data to the inference engine. Also the role constraint data and/or said entitlement constraint data are fed to the inference engine to obtain an inference result set defining said valid entitlements for said persons of said organization.

The invention is based on the insight that maintenance requirements of the system can be reduced by application of an inference engine and feeding the person classification data, the role classification data, the role constraint data and the entitlement constraint data to the inference engine. The inference engine allows determination of valid entitlements taking account of both the classification data and constraint data in the same determination step. Essentially, the only data to be entered in the system relate to personal classification data and role classification data as well as role constraint data and entitlement constraint data. From these data, the inference engine is capable of deducing the relationships between e.g. persons and entitlements and roles and entitlements. As a result, data entry in the system is reduced and maintenance of the system is facilitated.

It is not necessary for the method and system of the invention that the person classification data and role classification data contain entitlement classification data for the person and role respectively. However, even if such entitlement classification data is present, this does not automatically result in a valid entitlement to a resource of the person or role, since from the inference operation it may become apparent that the entitlement is not allowed as a result of the role constraint data and/or entitlement constraint data. The method according to the invention can not determine valid entitlements to resources without using the constraint data.

It should be understood that the determination of valid entitlements to resources generally precedes the phase of assigning entitlements to these resources, i.e. to grant access to these resources. The present invention relates to determining or evaluating the scope of available entitlements but does not necessarily involve the further step of assigning these entitlements.

Furthermore, it should be understood that an entitlement generally relates to the right to access and use a resource or to perform one or more operations on the resource.

Inference engines are generally known in the field of expert systems where these engines operate to deduce information from a large knowledge base. A knowledge base typically has a tree structure with several branches. Several algorithms are known to search for information in the tree structure. An algorithm may begin at a node that either represents the given data (forward chaining) or the desired goal (backward chaining) or a combination of both.

Finally, it should be appreciated that the system databases are not necessarily separate databases. It is relevant that the data are available for the inference engine at the relevant time, but the precise location or storage structure of the data is not relevant.

The invention also relates to a computer program and a computer system determining one or more valid entitlements for one or more persons to one or more resources of an organization.

Further embodiments and advantages of the invention are defined in the following description and in the appended claims. It should be appreciated that the invention is in no manner limited by these embodiments.

### SHORT DESCRIPTION OF THE DRAWINGS

FIG. 1 is a schematic illustration of a permission based access control method in accordance with the prior art;

FIG. 2 is a schematic illustration of a role based access control method in accordance with the prior art;

FIG. 3 shows a computer system for determining valid entitlements in accordance with an embodiment of the invention;

FIG. 4 is a schematic illustration of a method of determining valid entitlements in accordance with an embodiment of the invention;

FIG. 5 shows a hierarchical tree structure for illustrating the operation of an inference engine in accordance with an embodiment of the invention;

FIGS. 6A-6C show a hierarchical tree structure in accordance with a prior art method;

FIGS. 7A-7E illustrate examples of the method of FIG. 4 in accordance with embodiments of the invention;

FIG. 8 illustrates a further embodiment of the method of FIG. 4.

### DETAILED DESCRIPTION OF DRAWINGS

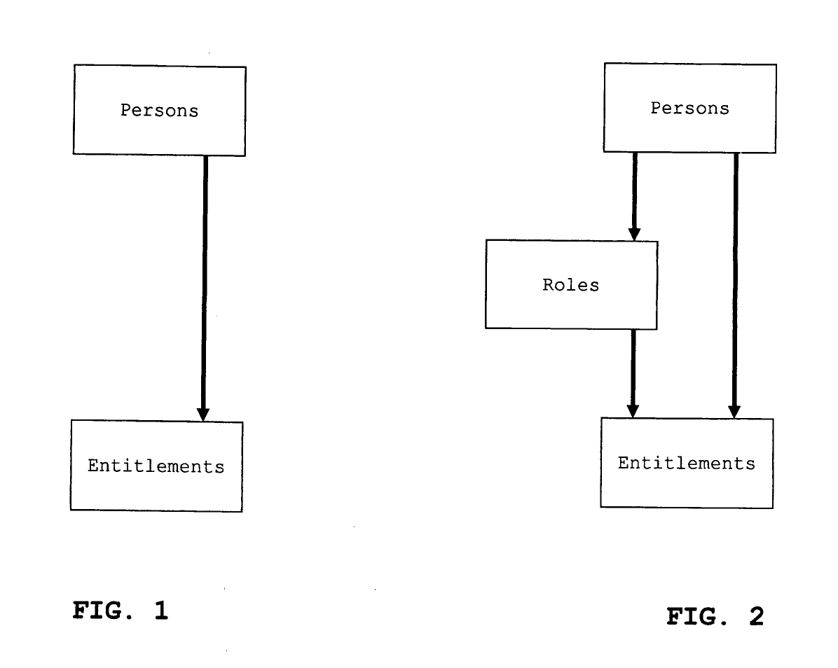

FIG. 1 is a schematic illustration of a permission based access control method in accordance with the prior art. In this method, person data (indicated by the block “Persons”) were entered into a database. Examples of such data include the name of the person (“John Doe”; “Jane Doe”) in combination with a social security number. Moreover, entitlement data for resources (indicated by the block “Entitlements”) were entered into the database. Examples of resources are applications from Microsoft Office®, such as Outlook 2007 and PowerPoint 2007, a Healthcare Sales Forecasting program, a Healthcare CRM program or the source code of Product Y. For each person, a link was defined to the entitlement or entitlements to resources for these persons. As an example, IT administrative staff had to enter into the database that Jane Doe was entitled to use Outlook 2007, PowerPoint 2007 and has access to the source code of Product Y of the organization after which Jane Doe was permitted to use these applications and to access the source code.

FIG. 2 is a schematic illustration of a role based access control (RBAC) method in accordance with the prior art. In this method, IT administrative staff fed the database with further data relating to a role of a person in the organization (indicated by the block “Roles”). Examples of such data are: “Sales Representative Healthcare” or “Software Engineer”. As indicated by the arrows, a person and/or a role could now be classified as being entitled to use a resource. These links or classifications had to be made by IT administrative staff. As an example, the person “Jane Doe” was linked to the role “Software Engineer”, whereas for this role a link to the entitlement to use the source code of Product Y of the organization was defined.

Both methods suffered from the fact that the question whether or not a person was granted access to a resource was finally determined by IT administrative staff. It was not possible to automatically implement organization wide compliance rules. Moreover, the increased number of links or classifications in RBAC required further labour intensive data input and was prone to errors.

A more recent method comprises the enterprise dynamic access control (EDAC) method prepared for Commander, U.S. Pacific Fleet, Version 2, retrievable from http://csrc.nist.gov/rbac. In this method, it is possible to take into account the complexity of contemporary organizations by entering further data in the database concerning several aspects of these organizations (indicated by the block “Model of Organization”). Examples of such data are: “Departments” (e.g. R&D) and “Products” (e.g. Product Y). After having defined the links or classifications between the several data, it is further possible with EDAC to define constraints in order to check whether or not the entitlements of persons to resources established in the previous step meet particular compliance rules of the organization.

The EDAC method requires IT administrative staff to enter further data to the database and to define the links or classifications between the various data in order to arrive at possible entitlements to resources for a person of the organization. Only after having defined the classifications, i.e. after most of the work has been done, EDAC allows to check the possible entitlements against compliance rules of the organizations by subjecting the possible entitlements to the constraints to arrive at a set of valid entitlements to resources of the organization for this person. Moreover, the applicants of the present invention have found that the EDAC method requires a very strict definition of the organization model for using this method.

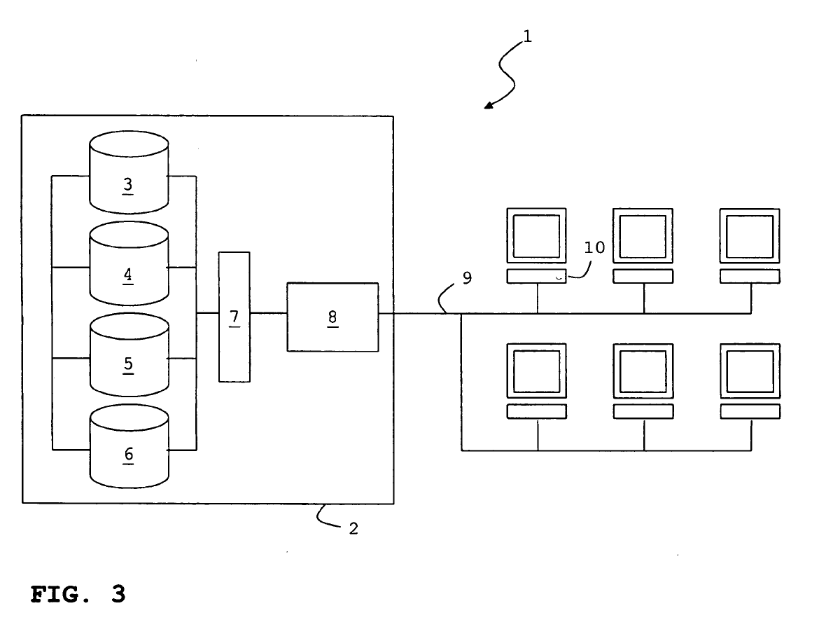

An embodiment of the invention of the applicant will now be explained with reference to FIGS. 3-5.

FIG. 3 is a schematic illustration of a computer system 1 for determining valid entitlements for a person of an organization. The computer system 1 comprises a server 2 containing an organizational model database 3, a person database 4, a role database 5 and an entitlement database 6. Furthermore, the server 2 includes a data retriever 7 and an inference engine 8. The server 2 is connected via a network 9 to a group of computers 10 for entering data in the databases and/or for receiving a result set of the inference engine 8. It should be appreciated that the set-up of the computer system 1 in FIG. 3 only intends to clearly define the relevant data for the inference engine and is not necessarily limited to the set-up shown in FIG. 3. In general, the computer system 1 should be such that the inference engine 8 is capable of accessing data required to determine a result set.

The organizational model database 3 contains organizational classification data defining aspects of the organization. These aspects of the organization are typically supplied by an organization expert. The data are organized such that the primary aspects (dimensions) are given a name (identification), whereas secondary aspects (classes) are give a name (identification) and a reference to a parent aspect. Examples of primary aspects of the organization are: “Departments”, “Products”, “Projects”, “Geography” and “Verticals”. Classes of the dimension “Departments” include: “Marketing”, “Sales”, “R&D”. Subclasses of the class “Marketing” include: “Product Marketing” and “Corporate Marketing”. Subclasses of the class “Sales” include: “Channel Management” and “Enterprise Sales”. Subclasses of the class “R&D” include: “Engineering” and “Development”. Classes of the dimension “Products” include: “Product X” and “Product Y”. A classes of the dimension “Projects” include: “Project A”. Classes of the dimension “Geography” include: “The Netherlands” and “United States of America”. Subclasses of the class “The Netherlands include: “Amsterdam” and “Den Bosch”. A subclass of “Den Bosch” may include: “Headquarters”. Further subclasses of “Headquarters” may include: “First Floor” and “Second Floor”. A subclass of the class “United States of America” may include: “Atlanta”. A subclass of the class “Atlanta” may include: “Sales Office”. Classes of the dimension “Verticals” may include: “Finance”, “Trade”, “Healthcare”, “Government”.

The below table 1 provides a condensed overview of the exemplary organizational classification data.

TABLE 1
Example of organizational classification data.

| Dimension | Class | Subclass | Subclass | Subclass |
|---|---|---|---|---|
| Departments | Marketing | Product | | |
| | | Marketing | | |
| | | Corporate | | |
| | | Marketing | | |
| | Sales | Channel | | |
| | | Management | | |
| | | Enterprise Sales | | |
| | R&D | Engineering | | |
| | | Development | | |
| Products | Product X | | | |
| | Product Y | | | |
| Projects | Project A | | | |
| | Project B | | | |
| Geography | Netherlands | Den Bosch | Headquarters | First Floor |
| | | | | Second |
| | | | | Floor |
| | | Amsterdam | | |
| | USA | Atlanta | Sales Office | |
| Verticals | Finance | | | |
| | Trade | | | |
| | Healthcare | | | |
| | Government | | | |

The person database 4 contains person identification data and person classification data. These data are typically already available from the Human Resource department of an organization.

The person identification data contain data of all persons in the organization and identify a particular person from these persons. As an example, person identification data include, apart from the name of the person (“John Doe”, “Jane Doe”) further data such as: gender, age, marital status and social security number. The person identification data for John Doe are e.g.: Male, 38 years, Married, Social security # xxx, and for Jane Doe: Female, 25 years, Single, Social security # yyy. The person identification data are typically data used by a person to access a resource, e.g. when he or she logs in onto a computer system.

The person database 4 also contains person classification data defining what aspects of the organization apply are associated with the person and/or what role or roles does the person have in the organization.

As an example, the organizational classification of John Doe may be that he is employed in subclass “Channel Management” of class “Sales” of dimension “Department”, whereas he is located in subclass “Sales Office” of subclass “Atlanta” of class “United States of America” of dimension “Geography”. On the other hand, role classification for John Doe may be that he is a “Sales Representative Healthcare”.

As a further example, the organizational classification of Jane Doe may be that she is employed in the subclass “Engineering” of the class “R&D” of the dimension “Departments”, whereas she is located in the subclass “First Floor” of the subclass “Headquarters” of the subclass “Den Bosch” of the class “The Netherlands” of the dimension “Geography”. An additional organizational classification may apply to Jane Doe, such as that she is working in the class “Product Y” of the dimension “Product”. The role classification for Jane Doe may be that she is a “Software Engineer”.

The role database 5 contains role classification data comprising organizational classification data defining one or more aspects of said organization for roles (functions) available in said organization. The role classification data have a name, a classification and one or more constraints. The constraints may be associated with the organizational classifycation data constraining roles to one or more aspects (dimensions or classes) of the organization or to identification data constraining one or more roles available in the organization to one or more persons.

As an example, for the role “Sales Representative Healthcare”, the organization classification data may be that this role is associated with the class “Healthcare” in the dimension “Verticals”. There may also exist a classification that a valid entitlement to the resource “Healthcare Sales Forecasting” application applies for this role. Furthermore, a constraint may apply, that this role only exists for subclasses of the class “Sales” in the dimension “Department”. In other words, the role “Sales Representative Healthcare” is only defined for the subclasses “Channel Management” and “Enterprise Sales”.

Another example is given for the role “Software Engineer”. For this role, a constraint may apply that this role exists only in the subclass “Engineering” of the class “R&D” of the dimension “Departments”.

The entitlement database 6 contains entitlement identification data and entitlement constraint data. The entitlement identification data identify the resources of the organization. Examples of these resources are: “Outlook 2007”, “PowerPoint 2007”, “Healthcare Sales Forecasting”, “Healthcare CRM, and “Product Y Source Code”. It should be appreciated that, although the present examples of resources all relate to computer applications or items, other resources of an organization may be used as well.

The entitlement constraint data may relate to the organizational classification data constraining the entitlement to resources to one or more aspects of the organization, to role classification data constraining the entitlement to resources to one or more roles in the organization and/or to person identification data constraining entitlement to one or more resources to one or more persons of the organization. The entitlement constraint data may e.g. be defined by an organization expert.

As an example, entitlement to the resource “Outlook 2007” may be constrained to all classes of the dimension “Departments”. Entitlement to the resource “PowerPoint 2007” may be constrained all subclasses of the classes “Marketing” and “Sales” of the dimension “Departments”. Entitlements to the resource “Healthcare Sales Forecasting” may be undefined and, consequently, the system 1 will not automatically determine valid entitlements for this resource. Entitlement to the resource “Healtcare CRM” may be constrained to the class “Healthcare” of the dimension “Verticals”. Entitlement to the resource “Product Y Source Code” is constrained by all subclasses of the class “R&D” of the dimension “Departments” and by the subclass “First Floor” of the subclass “Headquarters” of the subclass “Den Bosch” of the class “The Netherlands” of the dimension “Geography” and by the class “Product Y” of the dimension “Products” and by the role classification data “Software Engineer” or “Software Developer”.

Essentially, no classification data are required in the for the entitlement database 6.

The below table 2 provides an overview of the above examples:

TABLE 2

| | Identification | Classification | Constraint |
|---|---|---|---|
| Person | John Doe | Departments/Sales/Channel | |
| | Male, 38, | Management | |
| | Married | | |
| | Soc. # xxx | | |
| | | Geography/USA/Atlanta/ | |
| | | Sales Office | |
| | | Roles/Sales Rep. Health- | |
| | | care | |
| | Jane Doe | Departments/ | |
| | Female, 25, | R&D/Engineering | |
| | Single | | |
| | Soc. # yyy | | |
| | | Geography/Netherlands/Den | |
| | | Bosch/HQ/First Floor | |
| | | Products/Product Y | |
| | | Roles/Software Engineer | |
| Role | Sales Rep. | Verticals/Healthcare | Departments/Sales/* |
| | Healthcare | | |
| | | Entitlements/Healthcare | |
| | | Sales Forecasting | |
| | Software Engineer | | Departments/R&D/Engineering |
| Entitlements | Outlook 2007 | | Departments/* |
| | PowerPoint 2007 | | Departments/Marketing/* OR |
| | | | Departments/Sales/* |
| | Healthcare | | |
| | Sales Forecasting | | |
| | Healthcare CRM | | Verticals/Healthcare |
| | Product Y | | Departments/R&D/* |
| | Source Code | | |
| | | | Geography/Netherlands/Den |
| | | | Bosch/HQ/First Floor |
| | | | Products/Product Y |
| | | | Roles/Software Engineer OR |
| | | | Roles/Software Developer |

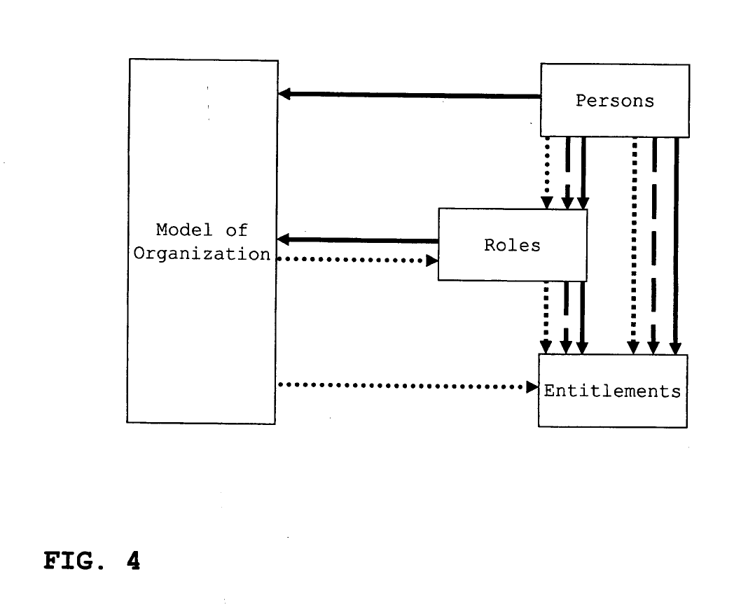

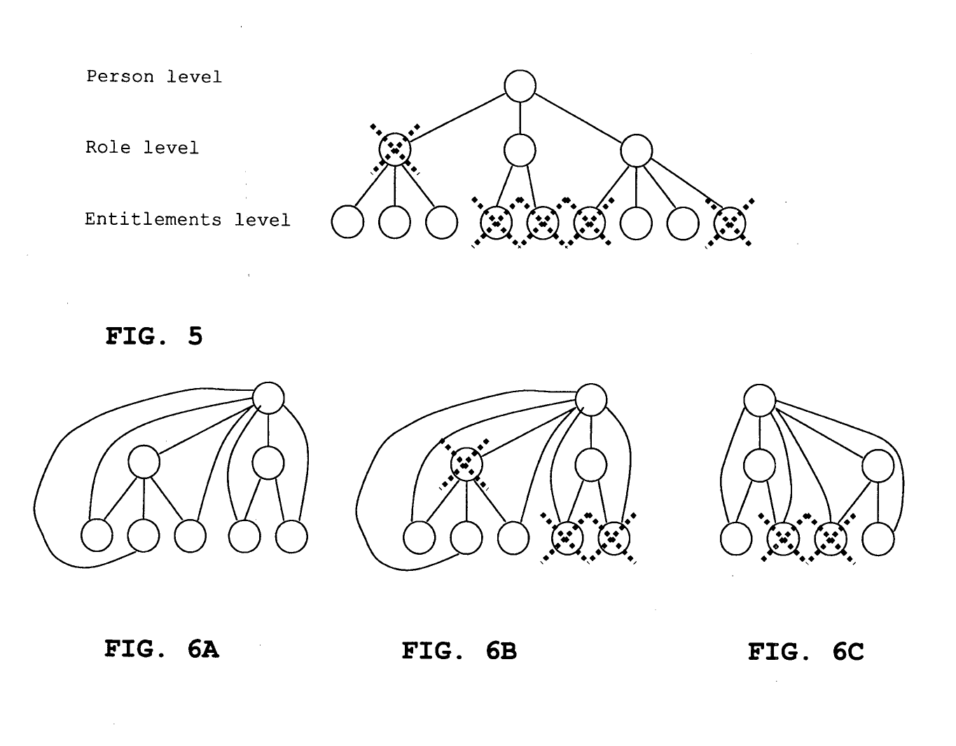

In order to determine which entitlements are valid for a person, the data retriever 7 retrieves the person classification data, the role classification data, the role constraint data and the entitlement constraint data from the respective databases and feeds these data to the inference engine 8. The inference engine 8 produces an inference result set defining the valid entitlements as will be described below in further detail with reference to FIGS. 4 and 5. It should be appreciated that the determination of valid entitlements to resources generally precedes the phase of assigning entitlements to these resources, i.e. to grant access to these resources. The determination of valid entitlements relates to determining or evaluating the scope of available entitlements but does not necessarily involve the further step of assigning these entitlements. This further step may be implemented in a workflow for which the determined valid entitlements serve as an input.

FIG. 4 is a schematic illustration of the method according to an embodiment of the invention using the computer system 1 as described with reference to FIG. 3.

The solid arrows illustrate the person classifications with respect to the organizational model, the roles and entitlements and the role classifications with respect to the organizational model and the entitlements.

The dotted arrows illustrate the role constraints with respect to persons and/or the organizational model and the entitlement constraints relating to persons and/or roles and/or the organizational model.

The dashed arrows illustrate the inference step made to automatically determine the valid roles and/or valid entitlements for a person and/or a role to one or more resources of the organization by feeding both the classification data and the constraint data to the inference engine 8. In contrast with the EDAC method as described above, classifications of persons and/or roles relating to the entitlements are no longer required, thereby saving efforts to fill the databases with these classifications. However, even if person classification data and role classification data exist that relate to the entitlements, the inference engine only determines such an entitlement valid if the applicable constraints are met. The embodiment of the present invention as shown in FIG. 4 takes direct account of the constraints in determining the valid entitlements, while the EDAC method first uses the classifications in order to find possible entitlements and only thereafter applies the constraints in order to find valid entitlements.

The operation of the inference engine 8 will now be explained with reference to FIG. 5. The inference engine is a tree traversal algorithm. The tree, illustrated in FIG. 5, is a treelevel node tree, comprising a “person” level (the top-node), a “role” level (the nodes on the first level) and an “entitlements” level (the nodes on the second level). The inference engine is an algorithm that is capable of matching constraints or collections of constraints with a classification or classification collection of a top-node. The tree is defined once and in order to obtain a result set from the inference engine 8 defining valid entitlements for a person and/or role to resources of an organization the constraints, indicated by the crosses in the tree of FIG. 5, for this person, role and/or entitlements are applied and the classification for this person and role are taken into account by a forward chaining algorithm of the inference engine 8. The pseudo code for the person classification data taking account of entitlement constraint data can be defined as follows:

Get(PersonClassificationCollection)
For each Entitlement in EntitlementCollection

Get (EntitlementConstraintCollection)
Compare
(PersonClassificationCollection,EntitlementConstraintCollection)

Next

In the “Compare” operation, the persons are matched against the entitlements.

The pseudo code for the person classification data taking account of the role constraint data and for the role classification data taking account of the entitlement constraint data can be defined as follows:

For each Role in Role Collection

Get(RoleConstraintCollection)
Compare(PersonClassificationCollection,RoleConstraintCollection)
Get (RoleClassificationCollection)
For each Entitlement in EntitlementCollection

Get(EntitlementConstraintCollection)
Compare(RoleClassificationCollection,EntitlementConstraintCollection).

Next

Next.

The above general pseudo code would provide duplicate results. Moreover, in order to only allow a Person in a particular Role to obtain a valid entitlement to use a resource, a PersonClassification and RoleClassification should be added to determine a valid entitlement of a Person in a Role. The below pseudo code takes these observations into account.

‘Get the PersonClassificationCollection and prepare the Tmp1 and Tmp2 collections’
Get(UserClassificationCollection)
Tmp1ClassificationCollection = Remove(UserClassificationCollection,Roles)
Tmp2ClassificationCollection = Remove(Tmp1ClassificationCollection,Entitlements)
For each Entitlement in EntitlementCollection

Get(EntitlementConstraintCollection)
Compare(Tmp1ClassificationCollection,EntitlementConstraintCollection)

Next
For each Role in RoleCollection

Get(RoleConstraintCollection)
‘Continue only for matching Roles’
If Compare(PersonClassificationCollection,RoleConstraintCollection) = TRUE,

then

Get(RoleClassificationCollection)
‘Add Person and Role classification collection to test Person in Role’
Add(RoleClassificationCollection,Tmp2ClassificationCollection)
For each Entitlement in EntitlementCollection

Get (EntitlementConstraintCollection)
Com-

pare(RoleClassificationCollection,EntitlementConstraintCollection)

Next

End if

Next

From the pseudo code, it should be clear that the method according to the embodiment of the invention as illustrated in FIGS. 4 and 5, only requires person classification data and/or role classification data and constraint data, retrieved in the pseudo code via the ‘Get’ command.

In order to further illustrate the difference between the method described with reference to FIGS. 3-5 in accordance with an embodiment of the invention and the EDAC method described above, reference is made to FIGS. 6A-6C. For ease of comparison, the EDAC method is depicted as a three-level tree but this does should not be construed as an indication or admission EDAC teaches or suggest to use a levelled tree structure for determining entitlements to resources by an inference engine.

As illustrated in FIG. 6A, when a person joins an organisation, the EDAC method requires first to define all links, i.e. classifications, between the person and roles on the one hand and the entitlements on the other hand. Then, in a next step, some of these already defined classifications appear to be not valid due to compliance rules expressed by the constraints (crosses) in FIG. 6B. For a next person, other classifications should be entered (see FIG. 6C) and afterwards, it may again become clear that the already defined classifications are not valid as a result of the constraints.

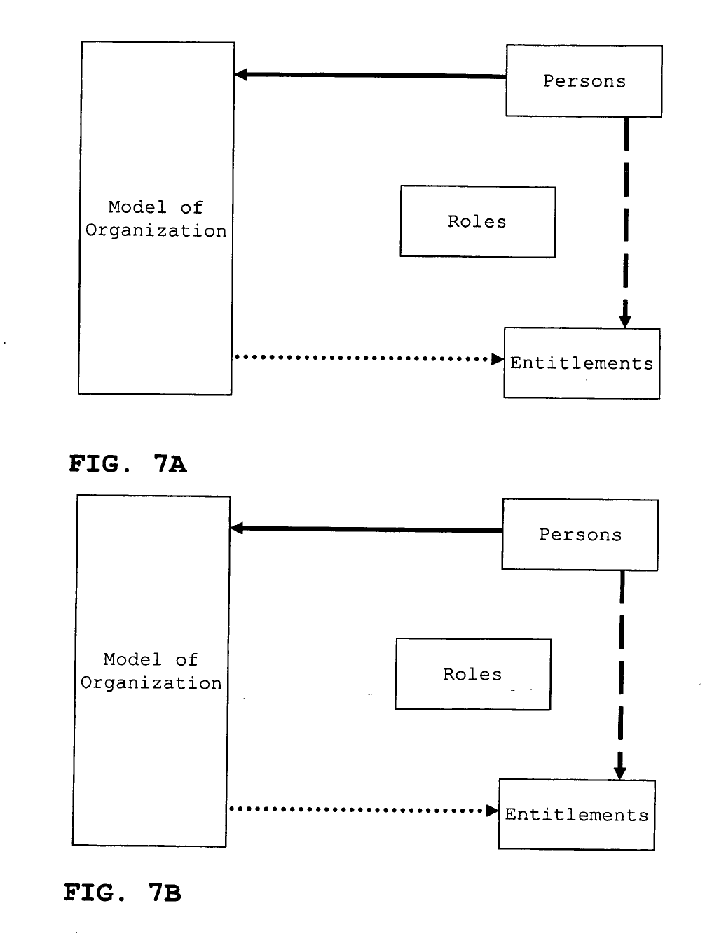

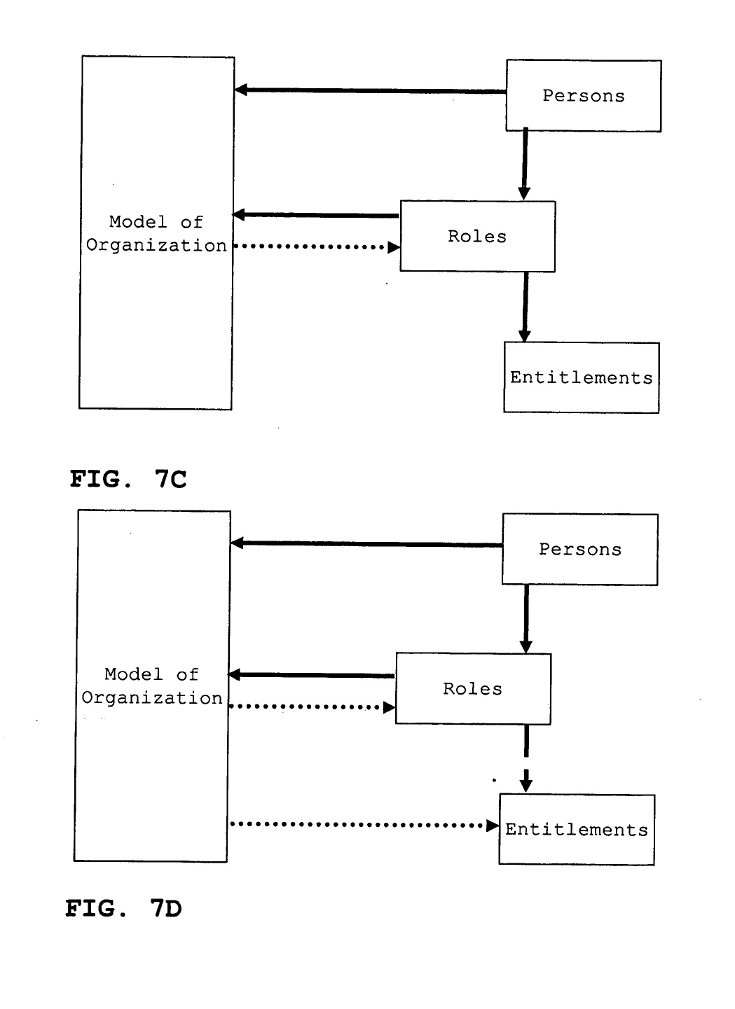

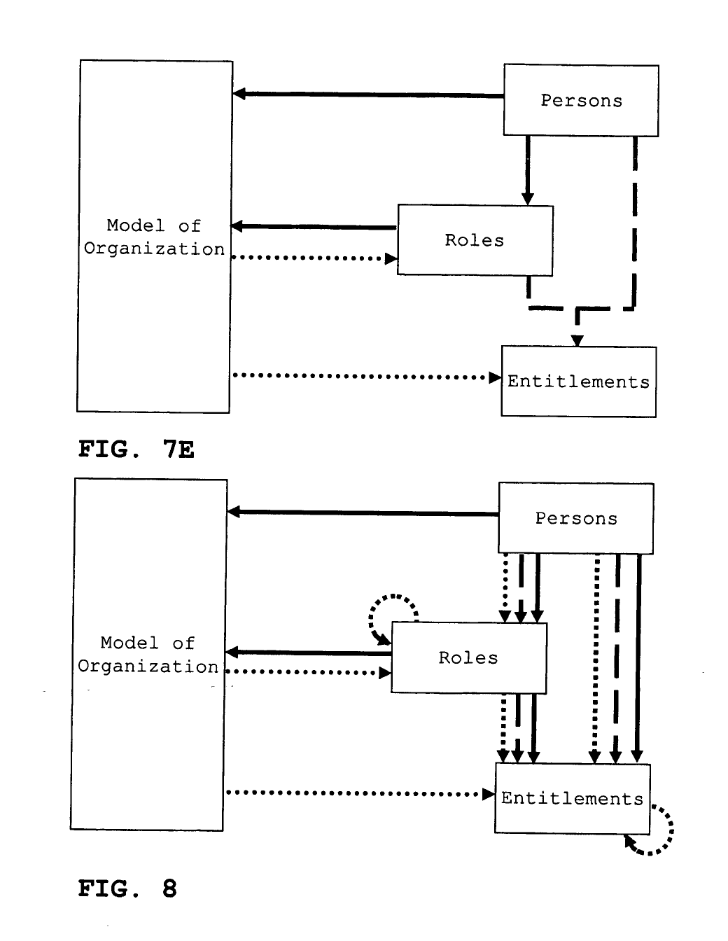

Next, a few examples of the method according to an embodiment of the invention as displayed in FIGS. 3-5 will be described with reference to FIGS. 7A-7E. For these examples, use is made from the data defined in the above tables.

In FIG. 7A, a schematic illustration is provided how a valid entitlement is determined to the resource “Outlook 2007” for the person “John Doe”. The person identification data for John Doe are: male, 38 years, married, social security # xxx. The person classification data (solid line) are: Departments/Sales/Channel Management and Geography/USA/Atlanta/Sales Office. The entitlement constraint data (dotted line) are: Departments/*, wherein the asterisk indicates that all classes of the dimension Department are entitled to use the resource “Outlook 2007”. The person classification data and the entitlement constraint data are fed to the inference engine 8 that determines, indicated by the dashed arrow in FIG. 7A, that a valid entitlement exists for John Doe to the resource “Outlook 2007”.

In FIG. 7B, a schematic illustration is provided how a valid entitlement is determined to the resource “PowerPoint 2007” for the person “John Doe”. Of course, the same identification data and personal classification data apply as for FIG. 7A. However, for the resource “PowerPoint 2000” the entitlement constraint data (dotted line) differ from the entitlement constraint data for “Outlook 2007”, as can be observed in table 2. In this example, the entitlement constraint data are: Departments/Marketing/* and Departments/Sales/*, meaning that a valid entitlement to the resource “PowerPoint 2007” only exists if John Doe is in the marketing department or the sales department. The person classification data and the entitlement constraint data are fed to the inference engine 8 that determines, indicated by the dashed arrow in FIG. 7B, that a valid entitlement exists for John Doe to the resource “PowerPoint 2007”.

In FIG. 7C, a schematic illustration is provided how an entitlement is determined to the resource “Healthcare Sales Forecasting” for the person “John Doe”. The person identification data for John Doe are: male, 38 years, married, social security # xxx. The person classification data (solid line) are: Departments/Sales/Channel Management and Geography/USA/Atlanta/Sales Office. Further person classification data now relate to the role defined for John Doe in the organization (vertical solid arrow), being: Sales Representative Healthcare. Furthermore, the role classification data (solid line starting from the box “Role”) for this role are: Verticals/Healthcare. The role constraint data are: Department/Sales/*. The person classification data, role classification data, role constraint data are fed to the inference engine 8 and the result set provides that the role “Sales Representative Healthcare” is valid for the person John Doe since it meets the role constraint data. However, since there are no entitlement constraint data applicable, the inference engine 8 does not determine a valid entitlement for John Doe to the resource “Healthcare Sales Forecasting”. The role, or better: the entitlement classification data defining one or more entitlements for a role, determine whether or not a valid entitlement exists to the resource “Healthcare Sales Forecasting”.

In FIG. 7D, a schematic illustration is provided how a valid entitlement is determined to the resource “Healthcare CRM” for the person “John Doe”. Again, the person classification data associated with the organization model are identical with those of FIGS. 7A and 7B. Further person classification data now relate to the role defined for John Doe in the organization (vertical solid arrow), being: Sales Representative Healthcare. Furthermore, the role classification data (solid line starting from the box “Role”) for this role are: Verticals/Healthcare. The role constraint data are: Department/Sales/*. Furthermore, the entitlement constraint data are: Vertical/Healthcare. The person classification data, role classification data, role constraint data and entitlement constraint data are fed to the inference engine 8 which infers from the data that a valid entitlement exists for John Doe to the resource “Healthcare CRM”.

Finally, in FIG. 7E, a schematic illustration is provided how a valid entitlement is determined to the resource “Product Y Source Code” for the person “Jane Doe”. The person identification data for Jane Doe are: female, 25, single, social security # yyy. The person classification data (solid lines) are: Departments/R&D/Engineering, Geography/Netherlands/Den Bosch/HQ/First Floor and Products/Product Y. The role constraint data are: Departments/R&D/Engineering. The entitlement constraint data are: Roles/Software Engineer or Roles/Software Developer, Departments/R&D, Geography/Netherlands/Den Bosch/HQ/First Floor and Products/Product Y. By feeding the person classification data, the role constraint data and the entitlement constraint data to the inference engine 8, it is determined that a valid entitlement exists for Jane Doe to the resource “Product Y Source Code”.

Finally, FIG. 8 illustrates an enhanced method according to an embodiment of the invention, wherein the diagram of FIG. 4 is extended with further reciprocal constraints (circular dotted lines). The reciprocal constraints allow the definition of incompatible roles and entitlements.

It should be acknowledged that the method according to the invention may also be used to determine persons having one or more entitlements and one or more roles or to determine roles associated with one or more persons and one or more entitlements. Such an application of the method may be useful for accounting purposes.

1. A method of determining one or more valid entitlements for one or more persons or roles to one or more resources of an organization using a computer system, wherein said computer system comprises an inference engine and at least one of an:
a) an organizational model database containing organizational classification data defining one or more aspects of said organization;
b) a person database containing:
person identification data of at least one person of said organization, and
person classification data, said person classification data comprising at least one of:
said organizational classification data defining one or more of said aspects of said organization for said person;
role classification data defining one or more roles of said person in said organization, and
entitlement classification data defining one or more entitlements for said person;
c) a role database containing:
said role classification data comprising at least one of:
organization classification data defining one or more aspects of said organization for roles available in said organization, and
entitlement classification data defining one or more entitlements for said role
and
role constraint data related to at least one of:
said organizational classification data constraining one or more of said available roles to one or more of said aspects of said organization, and
said person classification data constraining one or more of said available roles to one or more of said persons,
and
d) an entitlement database containing:
entitlement identification data defining said one or more resources of said organization, and
entitlement constraint data related to at least one of:
said organizational classification data constraining entitlement to said one or more resources to one or more of said aspects of said organization;
said role classification data constraining entitlement to said one or more resources to one or more of said available roles in said organization, and
said person classification data constraining entitlement to said one or more resources to one or more of said persons,
the method comprising the step of feeding at least one of said person classification data, said role classification data, said role constraint data and said entitlement constraint data to said inference engine to obtain an inference result set defining said valid entitlements for said persons of said organization.

2. The method according to claim 1, wherein the organizational classification data comprise a dimension identifier defining a name of one of said aspects of said organization and a class identifier defining a name of a secondary aspect of said one aspect and a parent identifier defining to which dimension or class the secondary aspect relates.

3. The method according to claim 2, wherein said dimension identifier are selected from the group comprising: a department identifier, a product identifier, a project identifier, a geographic identifier and a verticals identifier.

4. The method according to claim 1, wherein at least one of said role constraint data and said entitlement constraint data further define incompatible roles and incompatible entitlements respectively.

5. The method according to claim 1, wherein said inference engine uses forward chaining for determining said valid entitlements.

6. A computer program for determining entitlements for one or more persons or roles to one or more resources of an organization, said computer program comprising software code portions for retrieving person classification data, role classification data, role constraint data and entitlement constraint data from a computer system comprising:
a) an organizational model database containing organizational classification data defining one or more aspects of said organization;
b) a person database containing:
person identification data of at least one person of said organization, and
said person classification data comprising at least one of:
said organizational classification data defining one or more of said aspects of said organization for said person;
said role classification data defining one or more roles of said person in said organization, and
entitlement classification data defining one or more entitlements for said person;
c) a role database containing:
said role classification data comprising at least one of:
organization classification data defining one or more aspects of said organization for roles available in said organization, and
entitlement classification data defining one or more entitlements for said role;
and
said role constraint data related to at least one of:
said organizational classification data constraining one or more of said available roles to one or more of said aspects of said organization, and
said person data constraining one or more of said available roles to one or more of said persons,
and
d) an entitlement database containing:
entitlement identification data defining said one or more resources of said organization, and
said entitlement constraint data related to at least one of:
said organizational classification data constraining entitlement to said one or more resources to one or more of said aspects of said organization;
said role classification data constraining entitlement to said one or more resources to one or more of said available roles in said organization, and
said person classification data constraining entitlement to said one or more resources to one or more of said persons,
and for feeding at least one of said personal classification data, said role classification data, said role constraint data and said entitlement constraint data to said inference engine to obtain an inference result set defining said valid entitlements for said persons of said organization.

7. A computer system arranged for determining entitlements for one or more persons or roles to one or more resources of an organization comprising and inference engine and at least one of:
a) an organizational model database containing organizational classification data defining one or more aspects of said organization;
b) a person database containing:
person identification data of at least one person of said organization, and
person classification data, said person classification data comprising at least one of:
said organizational classification data defining one or more of said aspects of said organization for said person;
role classification data defining one or more roles of said person in said organization, and
entitlement classification data defining one or more entitlements for said person
c) a role database containing:
said role classification data comprising at least one of
organization classification data defining one or more aspects of said organization for roles available in said organization, and
entitlement classification data defining one or more entitlements for said role
and
role constraint data related to at least one of:
said organizational classification data constraining one or more of said available roles to one or more of said aspects of said organization, and
said person data constraining one or more of said available roles to one or more of said persons,
and
d) an entitlement database containing:
entitlement identification data defining said one or more resources of said organization, and
said entitlement constraint data related to at least one of:
said organizational classification data constraining entitlement to said one or more resources to one or more of said aspects of said organization;
said role classification data constraining entitlement to said one or more resources to one or more of said available roles in said organization, and
said person classification data constraining entitlement to said one or more resources to one or more of said persons,
wherein said computer system further comprises a data retriever arranged for retrieving at least one of said person classification data, said role classification data, said role constraint data and said entitlement constraint data and for feeding at least one of said personal classification data, said role classification data, said role constraint data and said entitlement constraint data to said inference engine to obtain an inference result set defining said valid entitlements for said persons of said organization.
